(19) United States
(12) Patent Application Publication
(10) Pub. No.: US 2006/0059210 A1
(43) Pub. Date: Mar. 16, 2006

(54) Generic database structure and related systems and methods for storing data independent of data type

(76) Inventors: Glynne MacDonald, Glenrothes (GB); Richard Oyston, Beckingham (GB); Salam Al-Rawi, Glasgow (GB)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/942,192

(22) Filed: Sep. 16, 2004

(51) Int. Cl. G06F 17/30

(52) U.S. Cl. 707/204

(57) ABSTRACT

A generic database structure is provided for storing data independent of data type. In particular, this invention pertains to a database wherein each record is divided into one or more keys used for identifying the record and an XML document for storing the substance of the record. When new data, which has an XML format, is input into the database, it is searched for the one or more keys, which are extracted and stored as one or more separate fields in the associated new record. When the substance of the records is queried, the associated XML documents are searched using techniques known in the art. According to this invention, the database structure remains constant regardless of the types of data stored in it.

### FIELD OF THE INVENTION

This invention relates to a generic database structure for storing data independent of data type and systems and methods for providing the same. In particular, this invention pertains to a database wherein each record is divided into one or more keys used for identifying the record and an XML document for storing the substance of the record. Consequently, the inventive database structure may store data without being limited to the type of data stored, and the database structure itself need not change to accommodate different types of data.

### BACKGROUND OF THE INVENTION

Conventionally, relational databases have been used which store data in tables. The columns in the tables each represent a data field for storing data of a particular data type, as shown in the example of FIG. 1. In FIG. 1, the table 101 stores information about bonds, in which column 102 represents a data field for storing a bond identifier, called a “CUSIP,” column 103 represents a data field for storing the name of the bond's issuer, and column 104 represents a data field for storing the date that the bond was issued. Each of these data fields has a data type. For instance, the CUSIP field 102, which is a nine character identifier in accordance with the CUSIP identifier format created and maintained by the Committee on Uniform Securities Identification Procedures, could have a data type of “string” or an array of characters. The Issuer Name field 103 also would likely have a data type of string. The issuer date field 103 could have a data type of “date.”

The rows 105-107 illustrate records in the table, where each record pertains to a single bond. In particular, row 105 stores information about a bond having a bond identifier of “CUSIP1,” which, for example, could be “442672 10 1”, in compliance with the CUSIP numbering format discussed. For the bond having CUSIP1, row 105 also stores the bond's issuer name “IssuerA” and the bond's issue date “Issue_date1,” which could be, for example, “General Motors” and “Oct. 1, 1999,” respectively. Rows 106 and 107 similarly store a CUSIP number, issuer name, and issuer date for their respective bonds.

A shortcoming of the conventional relational database is that if a data field is to be added to, deleted from, or modified in the database, the structure of the database must be changed to account for such changes. Returning to the example of FIG. 1, if maturity date and coupon (interest rate) data fields are desired, two new columns 108 and 109 must be added to table 101 to arrive at table 110. Conversely, if a data field is no longer desired, it must be deleted from the table. And, if the name of a data field is to be changed, the name of the associated column in the table must be changed. These changes are a significant problem in large systems because they require someone to manually change the structure of the database each time a change is required. Further, changes of the structure of the database can seriously impact programs that are developed around the relational database and are dependent upon the structure of such database.

Another shortcoming of conventional relational databases is that records in a database that have mutually exclusive fields are typically stored in separate tables. For instance, if records pertaining to stocks are needed in conjunction with the bond records shown in FIG. 1, the stock records typically would be stored in a separate table. If the stock records are to be stored in the same table as the bonds, additional columns would be added to account for the data fields required for the stocks. However, as shown at 111 in FIG. 1, the bond records 112 would not use all or most of the stock fields, and the stock records 113 would not use all or most of the bond fields, resulting in wasted memory 114 and 115.

Accordingly, a need in the art exists for a database structure that efficiently allows multiple record types in a single database and reduces the costs associated with changes in data fields in the database.

### SUMMARY OF THE INVENTION

These problems are addressed and a technical solution achieved in the art by a generic database structure for storing data independent of data type and systems and methods for providing the same. In particular, this invention pertains to a database wherein each record is divided into one or more keys used for identifying the record and a data file, such as an XML document, for storing the substance of the record. When new data, which in an embodiment has an XML format, is input into the database, it is searched for the one or more keys, which are retrieved and stored as one or more separate fields in the associated new record.

When the records are queried, it is first determined whether the query may be satisfied be searching the key fields. If so, the key fields are searched. If not, the data files, e.g., XML files in an embodiment of the invention, are searched using techniques known in the art, such as Oracle XML DB and Oracle Text.

According to this invention, the database structure remains constant regardless of the types of data stored in it. Consequently, a single database may be used to store multiple data types, and costs associated with adding, deleting, or modifying fields in a conventional database are reduces, if not eliminated.

### BRIEF DESCRIPTION OF THE DRAWINGS

A more complete understanding of this invention may be obtained from a consideration of this specification taken in conjunction with the drawings, in which:

FIG. 1 illustrates limitations of a conventional relational database;

FIG. 2 illustrates an example of the database structure according to an embodiment of the invention;

FIG. 3 illustrates a system for implementing the database structure according to an embodiment of the invention;

FIG. 4 illustrates a computer-executable process flow for storing data in the database structure according to an embodiment of the invention; and

FIG. 5 illustrates a computer-executable process flow for retrieving data from the database structure according to an embodiment of the invention.

### DETAILED DESCRIPTION OF THE EXEMPLARY EMBODIMENT(S) OF THE INVENTION

The database structure according to the present invention stores data without being limited to the type of data being stored, and the database structure itself need not change to accommodate different types of data.

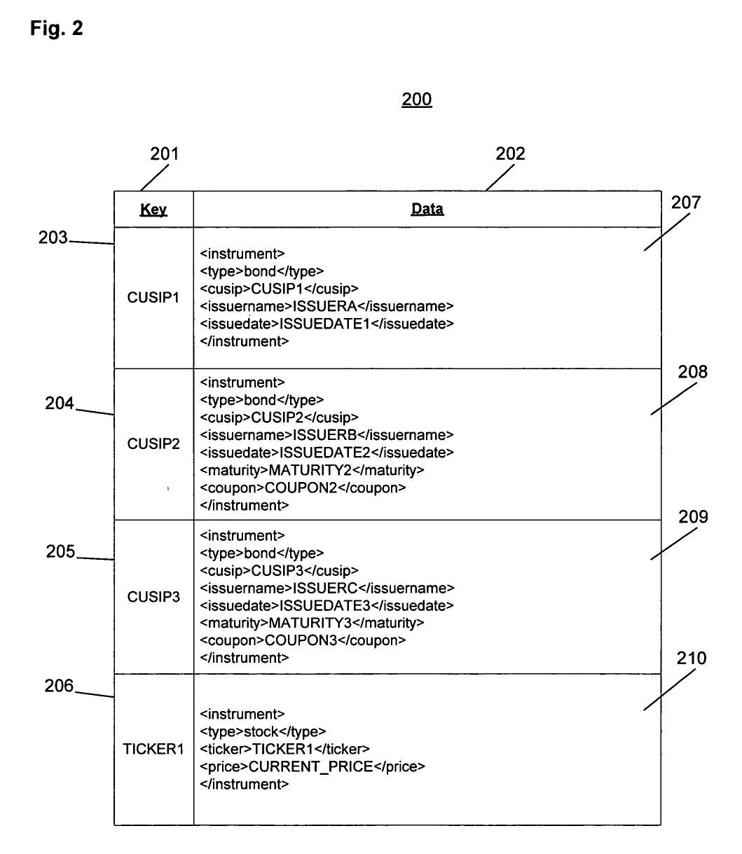

An exemplary embodiment of the inventive database structure is illustrated with FIG. 2. The database 200 is divided into a key field 201 and a data field 202. The key field 201 is for storing important data used to quickly identify the record in response to a query. In other words, the important data is data that is likely to be searched for in response to a query. In the example of FIG. 201, the important data for records 203-205 are CUSIP identifiers for bonds. Although one key field 201 is shown in FIG. 2, a plurality of key fields may be present to store a plurality of important data. The data field 202 is for storing all of the data for each record, which in an embodiment of the invention, is stored as an XML document. In other words, all of the data for a record is stored in a single XML document located in the data field 202. The database 200 does not verify the contents of the XML documents it stores, except that it verifies that they are well-formed XML. Accordingly, any type and sequence of data may be stored in the data field 202, so long is it is well-formed XML.

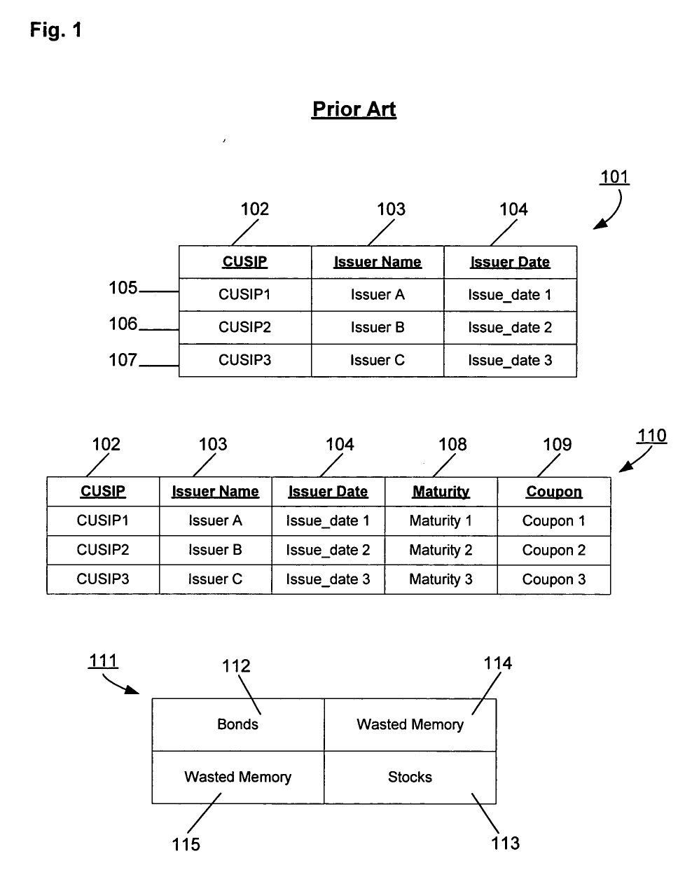

For an example comparable to that described with reference to FIG. 1, assume that a database of bonds is desired, and that a CUSIP number, an issuer name, and an issuer date are stored for each of the bonds. According to the embodiment of FIG. 2, in contrast to that shown in table 101 in FIG. 1, the inventive database has only two columns, or data fields: the key field 201 and the data field 202. The CUSIP number, issuer name, and issuer date are all stored in an XML document in the data field 202. However, the CUSIP number is also stored in the key field 201 to allow quick searching of it. If the issuer names or issue dates are queried, the XML documents in field 202 are queried to extract such information using, for example, an XPath query using Oracle Text.

Although the CUSIP number is shown as being duplicated in both of the fields 201 and 202, it may be removed from its XML document in field 202, if desired. In this situation, however, if the XML document is to be exported in its original form from the database, the CUSIP number will have to be re-inserted into the XML document prior to exportation.

Now assume that maturity date and coupon information needs to be added to the bond records. In the example of FIG. 1, new maturity and coupon fields 108 and 109 had to be added to the database, thereby changing its structure. However, according to the exemplary embodiment illustrated in FIG. 2, the database structure does not change. If maturity and coupon information is to be added, all that needs to change is the data contained in the XML documents in field 202. For example, assume record 203 was input at a time when maturity and coupon information was not recorded for the bonds. Consequently, the XML document 207 for record 203 does not contain such information. Then assume it is decided that maturity and coupon information are to be stored. Accordingly, the XML documents input into the database after this change in policy, such as documents 208 and 209 for records 204 and 205, respectively, contain such information. The structure of the database need not change to accommodate the additional data in the new records. It is up to the person in charge of the database to determine whether XML document 207 for record 203 should be updated to include maturity and coupon information. However, modification of document 207 is not necessary. Querying of the new maturity and coupon information may occur using techniques of querying XML documents known in the art, such as an XPath query using Oracle Text.

To further extend the example of FIG. 2, if a completely new record type is to be added to the same table, such as stock records, only the process of identifying the important information, such as the stock's identifier (“Ticker1” in record 206), need be adjusted. Although the contents of the XML document 210 for stock record 206 are different than the contents of XML documents 208 and 209, respectively, the structure of the database itself remains the same. With this inventive solution, the conventional problem of having to change the database structure to accommodate different data, and the conventional problem of excessive wasted memory 111 and 112 are resolved.

It should be noted that although the exemplary embodiment of FIG. 2 is described in the context of using XML documents in field 202, one skilled in the art will appreciate that any searchable data structure capable of storing a plurality of data may be used in place of the XML documents described herein. To elaborate, an XML document is essentially a tree-data structure with data located at leaf nodes. Because tree data structures may be searched using known techniques, XML documents have proven to be a preferred format for the data stored in field 202. However, the field 202 need not be limited to XML documents, and may instead store other tree-data structures, sorted lists, unsorted lists, or other data structures capable of storing a plurality of data elements, so long as the chosen data structure is searchable. Of course, the efficiency upon which the chosen data structure may be searched is an important consideration.

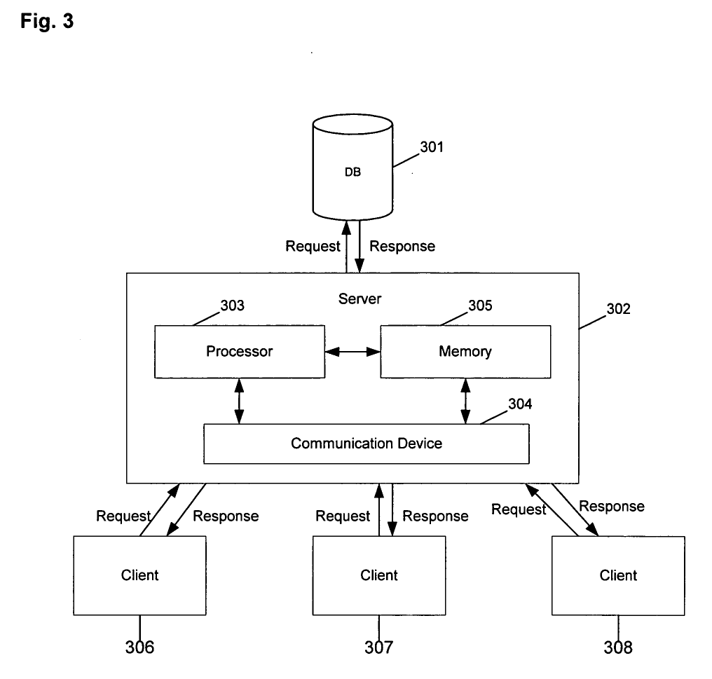

Turning now to FIG. 3, a system for implementing a database structure according to an embodiment of the invention is described. In particular, the inventive database 301 is communicatively connected to a server computer 302 and is stored on a computer-readable memory. The term “computer” is intended to refer to any data processing device, such as a desktop computer, a laptop computer, a personal digital assistant (“PDA”), etc., whether it be implemented electronically, optically, electo-optically, or by some other technology. The term “communicatively connected” is intended to refer to any method of communicating data between two devices, whether it be wired or wireless, or internally within a single computer or between separate computers. For instance, although the database 301 is shown separate from the sever 302, it may be stored in RAM located within the server computer 302, in an external hard disk drive connected via a USB cable to the server computer 302, or stored in a computer readable-memory located within a separate computer (not shown) communicatively connected to the server computer 302. The term computer-readable memory is intended to include any device for storing data that can be accessed by a computer, whether the storage be volatile or nonvolatile. One skilled in the art will appreciate that the invention is not limited to any specific configuration of computers or memories, and that the arrangement shown in FIG. 3 is merely an example.

The server computer 302 comprises a processor 303, communication device 304, and a memory 305 which may or may not contain the database 301 as discussed. The server may be communicatively connected to one or more client computers 306-308, which also comprise a processor, memory, and communication device (not shown). The client computers 306-308 request data from the database 301 or submit data to the database 301 for storage by sending a request to the server 302. The server computer 302 receives this request via its communication device 304, which may be a modem, network interface card (“NIC”) or other device known in the art. The processor 303 processes this request and submits it to the database 301. If the request is a request for data, the database 301 returns the requested data as a response to the processor 303, which processes the response, and forwards it to the client computer that requested the data. If the request is a request for storage, the data is stored in the database 301, and a response is not necessary.

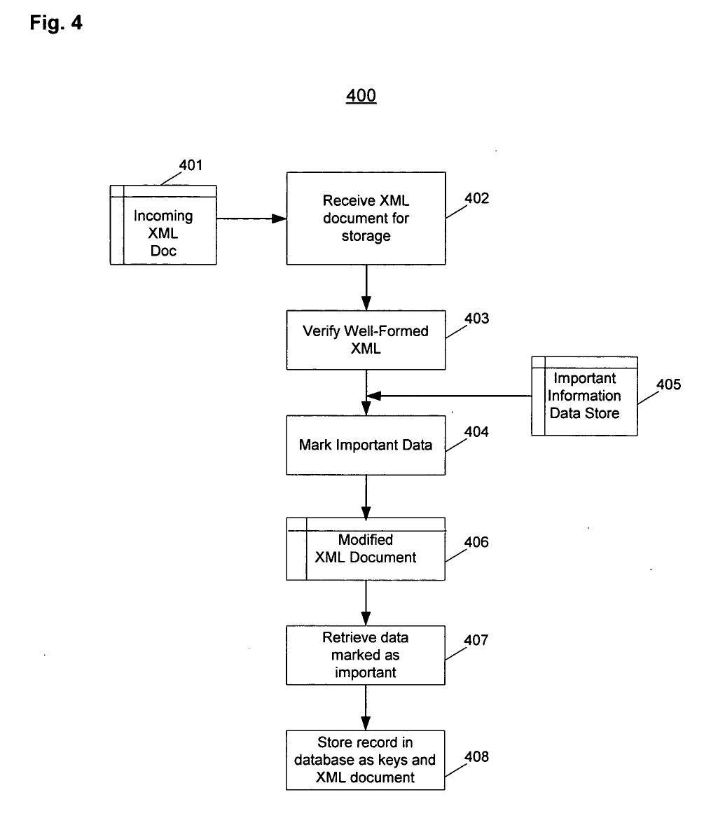

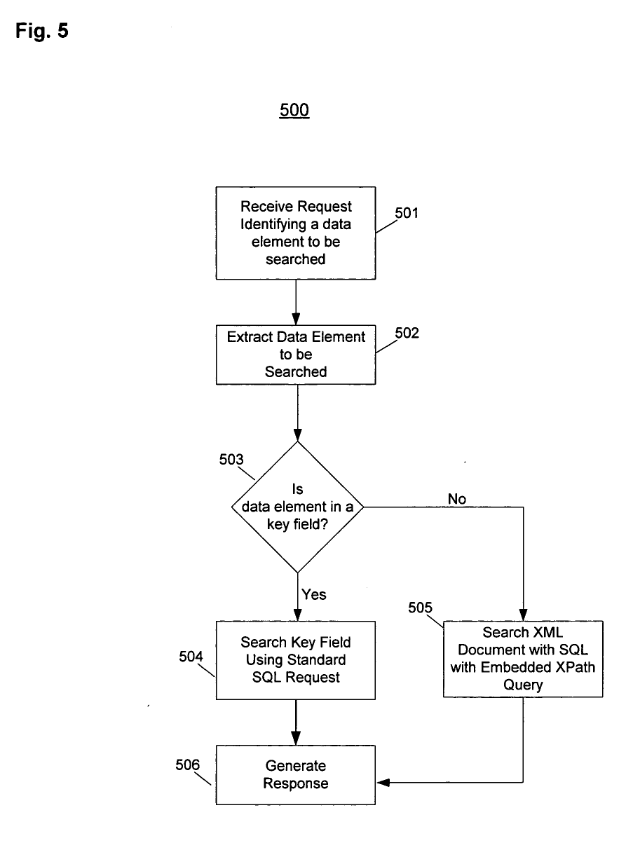

FIGS. 4 and 5 describe the processes of storing and requesting data, respectively, in more detail. The process 400 of storing new data will be described first with reference to FIG. 4. According to an embodiment of the invention, data to be stored is submitted as an XML document 401. At 402, such a document is received by the server computer 302 via its communication device 304. At 403, the received XML document is scanned to ensure that it has well-formed XML. At 404, any important data in the XML document is marked using an important information data store 405. The important information data store 405 tells the processor 303 what data in the AL document should be flagged for storage in the key data field 201. For example, assume that the incoming XML document appears as shown in Table I below:

TABLE I

<instrument>
<type>bond</type>
<cusip>CUSIP1</cusip>
<issuername>ISSUERA</issuername>
<issuedate>ISSUEDATE1</issuedate>
</instrument>

Also assume that the data store 405 appears as shown in Table II below:

TABLE II

| | | | |
|---|---|---|---|
| | Important Info 1 | Important Info 2 | |
| Instrument Type | for Key Field 1 | for Key Field 2 | . . . |

| | | |
|---|---|---|
| Bond | cusip | . . . |
| Stock | ticker | . . . |

In this example, the processor 303 recognizes that the XML document of Table I describes a bond by the “<bond>” tag. Once it recognizes that the document pertains to a bond, it then scans to find a “<cusip>” tag as specified in row 2 column 2 of Table II. Once the “<cusip>” tag is found, it is recognized as important data, and marked with, for instance, a “<key1>” tag as shown in Table III below. Another way to mark important data is to use XML attributes, such as “<cusip KEYFIELD=TRUE>”, instead of nested elements as shown in Table III. One skilled in the art will appreciate, however, that the invention is not limited to the manner in which important data is marked. The insertion of the tags or XML attributes may be performed using XSLT, known in the art.

TABLE III

<instrument>
<type>bond</type>
<key1>
<cusip>CUSIP1</cusip>
</key1>
<issuername>ISSUER1</issuername>
<issuedate>ISSUEDATE1 </issuedate>
</instrument>

If the database 301, shown for example at 200 in FIG. 2, has multiple key fields 201, the data store 405 specifies which important information should go to which key field, as shown by columns 2-4 in Table II. In this example, only important information for key field 1 is specified, and accordingly, the CUSIP identifier is marked for insertion into it with the <key1> tag.

The process at 404 outputs a modified XML document 406 that is input into a process 407 for scanning the modified XML document and retrieving all data marked with a key tag for storage into its associated key field. To continue with the running example, the modified XML document of Table III is scanned for any key tag, such as “<key1>”, “<key2>”, etc. Data retrieved from a <key1> tag is slotted for storage into a first key field in the database. Likewise, data retrieved from a <key2> tag is slotted for storage into a second key field in the database, and so on. In the example of Table III, CUSIP1 is retrieved and slotted for storage into a first key field, such as that shown at record 203 in FIG. 2. With the important information retrieved from the modified XML document, the important information is stored at 408 in the database 301 in its associated key fields, and the modified XML document is stored in the data field 202 in FIG. 2, for example.

An advantage of using the important information store 405 to mark key fields in the XML document 401 is that it allows flexibility in adapting the storage process 400 to accommodate new record types as well as new fields within records. For example, returning to FIG. 2, if a completely new record type for stocks 206 is to be added to the database, only the important information data store 405 needs to be updated to include a definition (row 3, table II, for instance) of what the important information is for this new record type. Once important information is marked in process 404 using the definitions in the data store 405, process 407 need not care what type of XML document 406 it is receiving. It need only look for data marked as important with tags <key1>, <key2>, etc. Accordingly, with only a single change at data store 405, the process 400 can accommodate any data type in an efficient manner.

Turning now to FIG. 5, the process 500 of retrieving data from the database 301 will be described. At 501, the server 302 receives a request that identifies a data element to be searched. For example, a request might be, “find a security having a CUSIP number of ‘CUSIP1.”’ In this example, CUSIP number is the data element to be searched. This data element is extracted from the request at 502. At 503, it is determined whether the data element belongs to a key field (201 in FIG. 2, for example) in the database 301. Assistance may be provided from the important information data store 405 if each key field includes different types of important information, as is the case in FIG. 2 where a single key field 201 includes bond CUSIP numbers and stock tickers.

If the data element belongs to a key field, the particular key field is searched at 504 using a traditional query, such as an SQL query, for the requested data. If the data element does not belong to a key field, the data field 202 in FIG. 2, for example, is searched at 505 using an SQL with embedded Xpath query, known in the art. The results of the searches at 504 or 505, whether successful or not, are formulated into a response at 506, which is sent back to the client computer as previously discussed with reference to FIG. 3.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

What is claimed is:

1. A method for storing data, comprising:
receiving a plurality of data for storing, the plurality of data being received in a searchable data structure;
retrieving key data from the searchable data structure;
storing as a record in a computer-readable database, the key data and the searchable data structure such that the key data and the searchable data structure are in separate fields in the database.

2. The method of claim 1 wherein the searchable data structure is an XML document.

3. The method of claim 2 wherein the XML document comprises data of multiple data types.

4. The method of claim 1 wherein the searchable data structure comprises data of multiple data types.

5. The method of claim 1 further comprising:
marking important information in the searchable data structure, the information marked as important indicating the key data to be retrieved from the data structure.

6. The method of claim 1 further comprising:
identifying a type of information that the searchable data structure describes using information provided by a data store, the data store identifying types of information and important information within each type; and
marking important information in the searchable data structure using the data store and the identified type of information that the searchable data structure describes, the information marked as important indicating the key data to be retrieved from the data structure.

7. The method of claim 1 wherein the key data represents a primary key.

8. The method of claim 1 wherein the key data represents a plurality of keys.

9. A method for retrieving data, comprising:
receiving a request for data;
determining whether the request pertains to data in a key field in the database;
searching the key field for a record having key data that fulfills the request, if it is determined that the request pertains to a key field in the database;
searching a data field in the database for a record having a searchable data structure comprising data that fulfills the request, if it is determined that the request does not pertain to a key field in the database; and
transmitting one or more records determined to fulfill the request.

10. The method of claim 9 wherein the searchable data structure is an XML document.

11. The method of claim 10 wherein the XML document comprises data of multiple data types.

12. The method of claim 10 wherein the searchable data structure comprises data of multiple data types.

13. The method of claim 10 wherein the key data represents a primary key.

14. The method of claim 10 wherein the key data represents a plurality of keys.

15. A computer-readable memory encoded with data representing a database, the memory comprising:
a plurality of searchable data structures each storing a plurality of data; and
for each searchable data structure, key data retrieved from the associated searchable data structure,
wherein a combination of key data and one of the searchable data structures is a record in the database, and the key data facilitates rapid identification of the associated record.

16. The memory of claim 15 wherein the searchable data structures are XML documents.

17. The memory of claim 16 wherein the XML documents comprise data of multiple data types.

18. The memory of claim 15 wherein the searchable data structures comprise data of multiple data types.

19. The memory of claim 18 wherein at least some of the searchable data structures comprise data of different data types than the other searchable data structures.

20. The memory of claim 15 wherein the key data represents a primary key.

21. The memory of claim 15 wherein the key data represents a plurality of keys.

22. A system for storing and retrieving data, comprising:
a processing component;
a communication device communicatively connected to the processing component by which the processing component receives requests for data and transmits responses to the requests; and
a computer-readable memory according to claim 15 that is communicatively connected to the processing component, to which the processing component submits data requests and receives responses to the requests.

23. The system according to claim 22, further comprising:
a server computer comprising the processing component and the communication device; and
a client computer communicatively connected to the server computer,
wherein the client computer transmits data requests to the server computer, and the server computer transmits responses to the requests to the client computer.

24. The system according to claim 22, further comprising:
a server computer comprising the processing component, the communication device, and the computer-readable memory; and
a client computer communicatively connected to the server computer,
wherein the client computer transmits data requests to the server computer, and the server computer transmits responses to the requests to the client computer.
